(19) United States
(12) Patent Application Publication
(10) Pub. No.: US 2025/0339907 A1
(43) Pub. Date: Nov. 6, 2025

(54) HYDRAULIC TOOL

(71) Applicant: Milwaukee Electric Tool Corporation, Brookfield, WI (US)

(72) Inventor: Marc D'Antuono, Whitefish Bay, WI (US)

(21) Appl. No.: 19/269,338

(22) Filed: Jul. 15, 2025

Related U.S. Application Data
(63) Continuation of application No. 17/463,251, filed on Aug. 31, 2021, now Pat. No. 12,365,039.
Application No. 17/463,251 is a continuation of application No. 16/534,541, filed on Aug. 7, 2019, now Pat. No. 11,103,941.
(60) Provisional application No. 62/726,013, filed on Aug. 31, 2018.

(51) Int. Cl. B23D 29/00; B23D 27/04; B23D 35/00; B25F 5/02

(52) U.S. Cl. CPC B23D 29/002; B23D 27/04; B23D 35/002; B25F 5/021

(57) ABSTRACT

A blade retainer includes a first end face defining a first end of the blade retainer, a second end face opposite the first end face and defining a second end of the blade retainer, and a first contacting face positioned between the first end face and the second end face. The first contacting face is configured to contact a blade.

### CROSS REFERENCE TO RELATED APPLICATIONS

The present application is a continuation of U.S. patent application Ser. No. 17/463,251, filed Aug. 31, 2021, which is a continuation of U.S. patent application Ser. No. 16/534,541, filed Aug. 7, 2019, which claims priority to U.S. Provisional Application No. 62/726,013 filed Aug. 31, 2018, the contents of which are hereby incorporated by reference in their entirety.

### FIELD

The present disclosure relates generally to power tools. More particularly, the present disclosure relates to a hand-held shearing power tool.

### BACKGROUND

A hydraulic shearing tool can be used to shear a workpiece. For example, the hydraulic shearing tool may be used to snap a multi-stranded steel wire (between 3 and 19 strands wound together) into separate pieces. In such tools, a hydraulic pump is typically utilized for pressurizing hydraulic fluid and transferring it to a cylinder of the tool. This cylinder causes an extendible piston to be displaced towards a shearing head. The piston exerts a force on the shearing head, which typically includes opposed jaws with certain shearing features, depending upon the particular configuration of the tool. In this case, the force exerted by the piston can be used for closing the jaws to perform a shearing action on the work piece at a desired location.

Some shearing tools are configured to shear a particular type of metal wire having one or more layers comprising multiple soft metal strands (e.g., aluminum strands) that surround a hard metal core (e.g., steel). During use, the hard metal core will often resist shearing and exert forces against the jaws. These forces are transverse to the shearing plane of the tool. As such, these shearing tools often have a blade retainer installed on one of the jaws. The blade retainer resists movement of the jaws that is transverse to the shearing plane. Such blade retainers are typically sized and positioned to engage the opposing jaw after shearing of the soft metal sleeve has already been performed. Thus, if the tool is used to shear a similarly sized workpiece that includes a thicker hard metal core, the workpiece generally begins exerting the transverse forces before engagement of the blade retainer, causing the sheared edge to be crooked, or preventing the shearing operation from being completed at all.

Additionally, such blade retainers are typically fastened to a jaw with fasteners such as threaded bolts. If the tool is dropped by a user such that the blade retainer absorbs the impact, the threaded bolts can break due to the absorbed shear forces, and the blade retainer is no longer attached to the jaw.

Therefore, there is a need for a hydraulic shearing tool having a blade retainer that is attached to a jaw of the tool in a drop-resistant manner. There is also a need for a blade retainer that engages the opposing jaw of the shearing tool at an earlier stage of the shearing stroke.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In some aspects, a blade retainer configured to couple to a blade can include a first end face defining a first end of the blade retainer, a second end face opposite the first end face and defining a second end of the blade retainer, and a first contacting face positioned between the first end face and the second end face. The first contacting face can be configured to contact the blade.

In some examples, the blade retainer can further include a channel extending from the first end face toward the second end face.

In some examples, a recess can be defined within the channel, the recess defined by the first contacting face.

In some examples, the blade retainer can further include a second contacting face defining the recess, the second contacting surface extending from the first contacting face and toward the second end face.

In some examples, the blade retainer can further include a third contacting face defining the recess, the third contacting surface extending from the first contacting face toward the second end face.

In some examples, the first contacting face can be perpendicular to the second contacting face and the third contacting face, and the second contacting face can be perpendicular to the third contacting face.

In some examples, the third contacting face can define an opening configured to receive a fastener for attaching the blade retainer to the blade.

In some examples, the first contacting face can be parallel to the first end face.

In some examples, the blade retainer can further include a first outer face extending from the first end face to the second end face, a second outer face opposite the second end face, the second outer face extending from the first end face to the second end face, and a third outer face extending from the first end face to the second end face and from the first outer face to the second outer face.

In some examples, the first outer face can be parallel to the second outer face, and the third outer face can be perpendicular to the first outer face.

In some aspects, a blade retainer configured to couple to a blade can include a retainer body including a first leg, a second leg, and a channel extending between the first leg and the second leg. The first leg can define a recess within the channel, the recess configured to receive the blade.

In some examples, the first leg can define a first surface corresponding to a first end of the retainer body and a second surface corresponding to a second end of the retainer body, and the recess can be defined by a third surface that is configured to engage the blade.

In some examples, the recess can be further defined by a fourth surface and a fifth surface, each of the fourth surface and the fifth surface configured to engage the blade.

In some examples, the third surface, the fourth surface, and the fifth surface can be perpendicular to one another.

In some examples, the first leg can define a hole configured to receive a fastener for attaching the blade retainer to the blade.

In some examples, the hole can be positioned within the recess.

In some aspects, a power tool can include a first blade defining a first shearing surface, a second blade defining a second shearing surface and a first surface that faces the first shearing surface, and a blade retainer including a first retainer surface in contact with the first surface.

In some examples, at least one of the first blade and the second blade can be moveable along a shearing plane and the first surface can be at a non-zero angle relative to the shearing plane.

In some examples, the second blade can define a second surface and the blade retainer can define a second retainer surface in contact with the second surface, and the second blade can define a third surface and the blade retainer can define a third retainer surface in contact with the third surface.

In some examples, the second surface can be parallel to the shearing plane and the third surface can be perpendicular to the first surface and the shearing plane.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and descriptions thereof, will best be understood by reference to the following detailed description of an illustrative embodiment of the present disclosure when read in conjunction with the accompanying drawings, wherein:

FIG. 1A is a schematic diagram of a hydraulic shearing tool, according to an example.

FIG. 1B is a front view of a shearing head, according to an example.

FIG. 2 is a rear view of a shearing head, according to an example.

FIG. 3 is a perspective view of a shearing head, according to an example.

FIG. 4 is another perspective view of a shearing head, according to an example.

FIG. 5 is an exploded view of a shearing head, according to an example.

FIG. 6 is a close up view of a blade retainer, according to an example.

FIG. 7 is another close up view of a blade retainer, according to an example.

FIG. 8 is another sectioned view of a blade retainer, according to an example.

FIG. 9 is a top view of a shearing head, according to an example.

FIG. 10 is another top view of a shearing head, according to an example.

### DETAILED DESCRIPTION

Disclosed embodiments will now be described more fully hereinafter with reference to the accompanying drawings, in which some, but not all of the disclosed embodiments are shown. Indeed, several different embodiments may be provided and should not be construed as limited to the embodiments set forth herein. Rather, these embodiments are provided so that this disclosure will be thorough and complete and will fully convey the scope of the disclosure to those skilled in the art.

By the term “about” or “substantially” with reference to amounts or measurement values described herein, it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

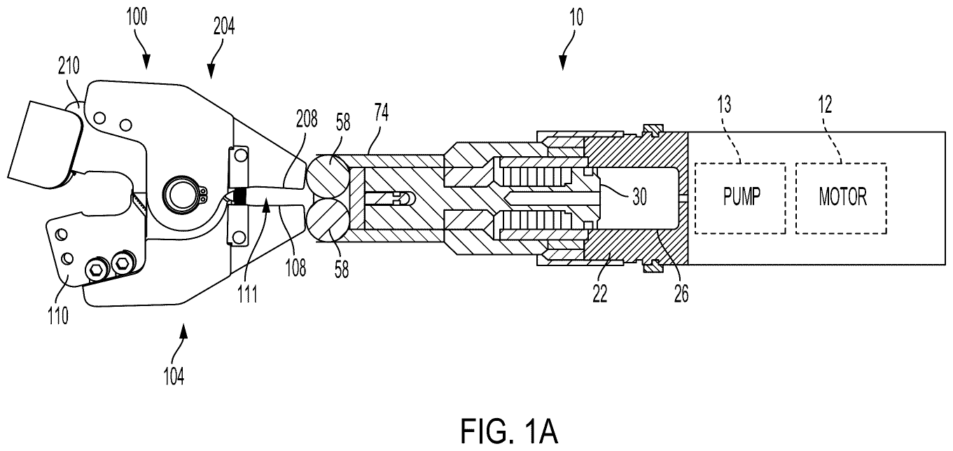

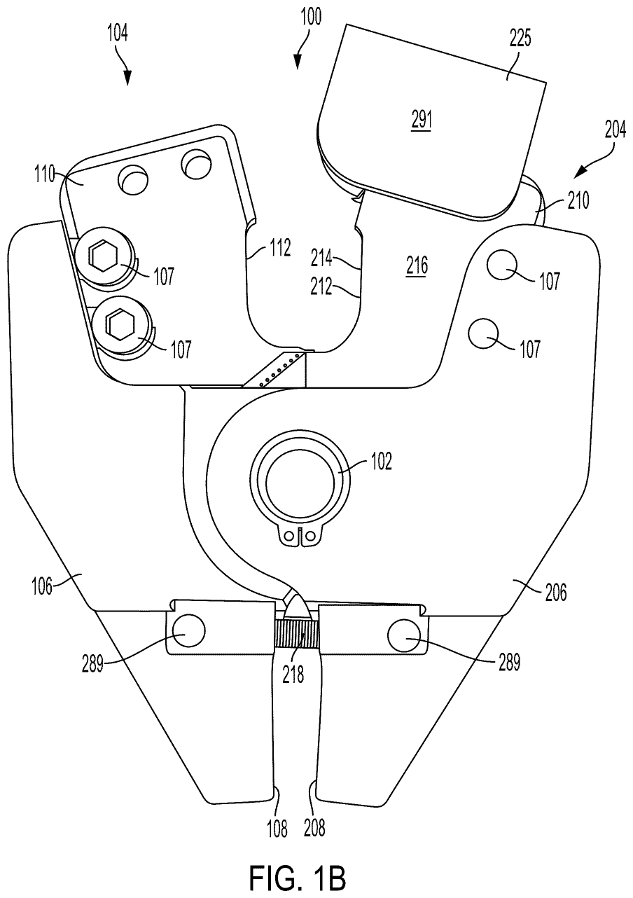

FIG. 1A illustrates a hydraulic power tool 10 that includes a biased open shearing head 100. The hydraulic power tool 10 includes a shearing head 100, an electric motor 12, a pump 13 driven by the motor 12, and a housing 22 defining a cylinder 26 therein. An extendable piston 30 is disposed within the cylinder 26. The pump 13 can provide pressurized hydraulic fluid to the cylinder 26, causing the piston 30 to extend from the housing 22 to thereby actuate a first jaw 104 and a second jaw 204 of the shearing head 100 for shearing a work piece, such as a guy wire (e.g, zinc-coated steel wire strand ASTM 475).

In operation, the piston 30 moves a set of rollers 58 towards the shearing head 100. (The rollers 58 are not to scale in FIG. 1A). As the set of rollers 58 begins to enter a cavity 111 defined by the first jaw 104 and the second jaw 204, the set of rollers 58 bear against a first cam surface 108 and a second cam surface 208. As the rollers 58 are inserted into the cavity 111, the first shearing member 110 of the first jaw 104 and the second shearing member 210 of the second jaw 204 close (e.g., rotate toward each other).

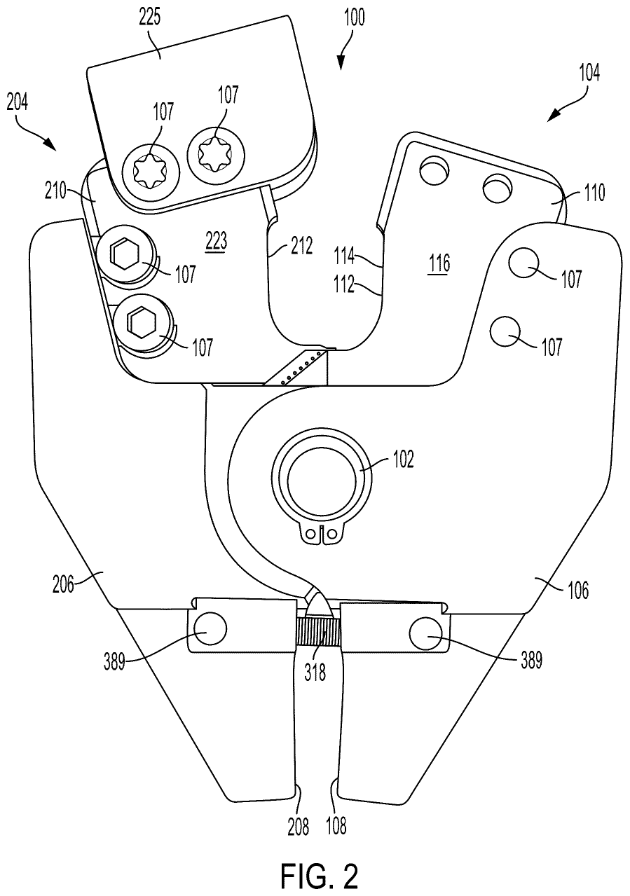

FIG. 1B is a front view of the shearing head 100. The shearing head 100 includes a pin 102 (e.g., a hollow metal tube) and the first jaw 104 (e.g., a metal jaw) that is rotatable about the pin 102. The first jaw 104 includes a first actuation member 106 (e.g., metal) having a first cam surface 108. The pin 102 passes through the first actuation member 106. The first jaw 104 is configured to rotate in response to a (leftward) force being applied to the first cam surface 108. The first jaw 104 also includes a first shearing member 110 (e.g., metal) having a first shearing surface 112 that forms a first substantially right angle 114 with a first lateral surface 116 of the first shearing member 110 (see FIG. 2). The first shearing member 110 is attached to the first actuation member 106 (e.g., threaded holes within the first actuation member 106) via fasteners 107 (e.g., threaded bolts) (see also FIG. 2), such that force applied to the first cam surface 108 is translated to the first shearing member 110.

The shearing head 100 also includes a second jaw 204 (e.g., metal jaw) that is rotatable about the pin 102. The second jaw 204 includes a second actuation member 206 (e.g., metal) having a second cam surface 208. The pin 102 passes through the second actuation member 206. The second jaw 204 is configured to rotate in response to a force being applied to the second cam surface 208. The second jaw 204 also includes a second shearing member 210 (e.g., metal) having a second shearing surface 212 that forms a second substantially right angle 214 with a second lateral surface 216 of the second shearing member 210. The second shearing member 210 is attached to the second actuation member 206 (e.g., threaded holes within the second actuation member 206) via fasteners 107 (e.g., threaded bolts), such that force applied to the second cam surface 208 is translated to the second shearing member 210.

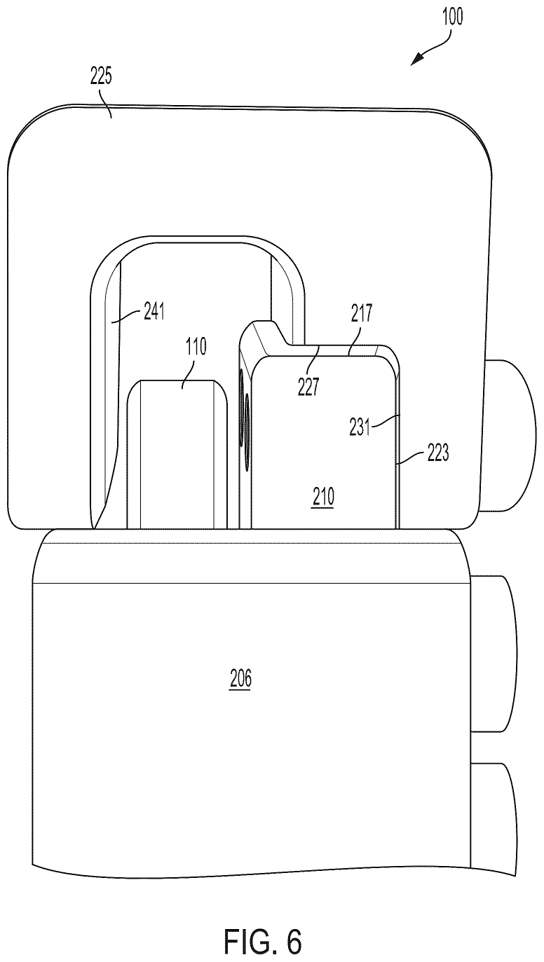

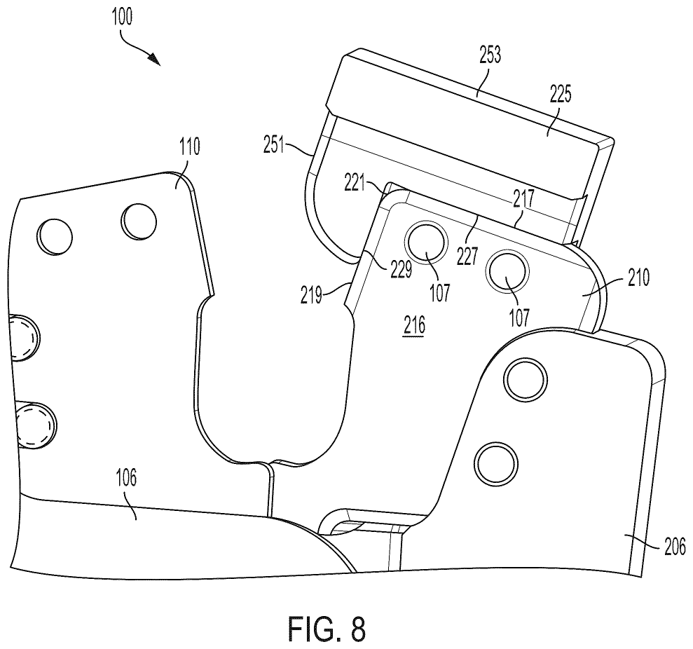

Referring to FIG. 8, the second shearing member 210 includes a first distal surface 217 and a second distal surface 219 that form a substantially right angle 221. In FIG. 8, a portion 291 (shown in FIG. 1B) of a blade retainer 225 (e.g., formed of metal) has been removed for clarity. The substantially right angle 221 can take the form of a gradual or rounded transition between the first distal surface 217 and the second distal surface 219 that are substantially perpendicular to each other. The first distal surface 217 and the second distal surface 219 are substantially perpendicular to the second lateral surface 216. The second shearing member 210 includes a third lateral surface 223 that is opposite the second lateral surface 216 (see FIGS. 2 and 6).

Referring to FIG. 1B, the shearing head 100 also includes an extension spring 218 configured to resist (i) separation of the first cam surface 108 and the second cam surface 208 and (ii) movement of the first shearing surface 112 toward the second shearing surface 212. The extension spring 218 can be fastened to the first actuation member 106 and to the second actuation member 206 respectively via fasteners 289.

Referring to FIG. 2, the shearing head 100 also includes an extension spring 318 configured to resist (i) separation of the first cam surface 108 and the second cam surface 208 and (ii) movement of the first shearing surface 112 toward the second shearing surface 212. The extension spring 318 can be fastened to the first actuation member 106 and to the second actuation member 206 respectively via fasteners 389.

Referring to FIG. 8, the shearing head 100 also includes the blade retainer 225 attached to the second shearing member 210 (e.g., via fasteners 107 and threaded holes within the second shearing member 210). The blade retainer 225 is configured, during a shearing action, to resist movement of the first shearing member 110 that is transverse to a shearing plane or movement of the second shearing member 210 that is transverse to the shearing plane. In FIG. 1B or FIG. 2, the shearing plane would be parallel to the paper.

Referring to FIG. 8, a first surface 227 of the blade retainer 225 fixedly contacts the first distal surface 217, a second surface 229 of the blade retainer 225 fixedly contacts the second distal surface 219, and the third lateral surface 223 of the second shearing member 210 (see FIG. 6) fixedly contacts a third surface 231 of the blade retainer 225. The blade retainer 225 can be attached to the second shearing member 210 via fasteners 107, for example. Typically, the first surface 227, the second surface 229, and the third surface 231 are orthogonal to each other.

As shown in FIG. 8, the blade retainer 225 advantageously extends beyond the second shearing member 210 in a direction parallel to the first distal surface 217 and in a direction parallel to the second distal surface 219. Thus, in the event a user drops the hydraulic power tool 10 such that a surface 251 or a surface 253 of the blade retainer 225 is impacted, the impact will be compressively absorbed by the second distal surface 219 and/or the first distal surface 217, thus preventing damage (e.g., breakage) to the fasteners 107 shown in FIG. 8.

Another advantage of the blade retainer 225 extending beyond the second shearing member 210 in the direction parallel to the first distal surface 217 is that the blade retainer 225 will engage the first shearing member 110 at an earlier stage of the shearing stroke than would otherwise be possible. This enables the shearing head 100 to shear wires or other workpieces having thicker diameters of hardened material (e.g., steel).

FIG. 2 is a rear view of the shearing head 100.

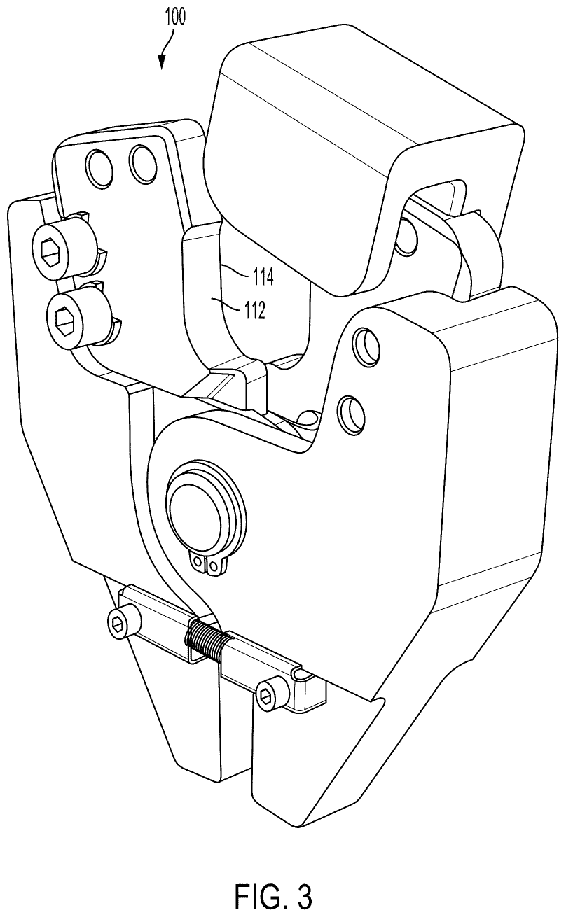

FIG. 3 is a perspective view of the shearing head 100. FIG. 3 shows the first shearing surface 112 and the first substantially right angle 114, among other features.

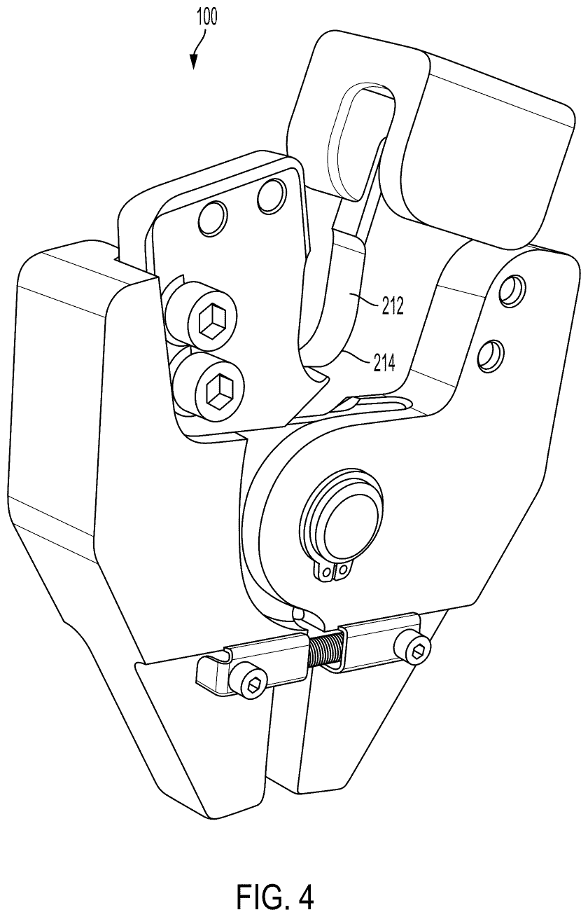

FIG. 4 is another perspective view of the shearing head 100. FIG. 4 shows the second shearing surface 212 and the second substantially right angle 214, among other features.

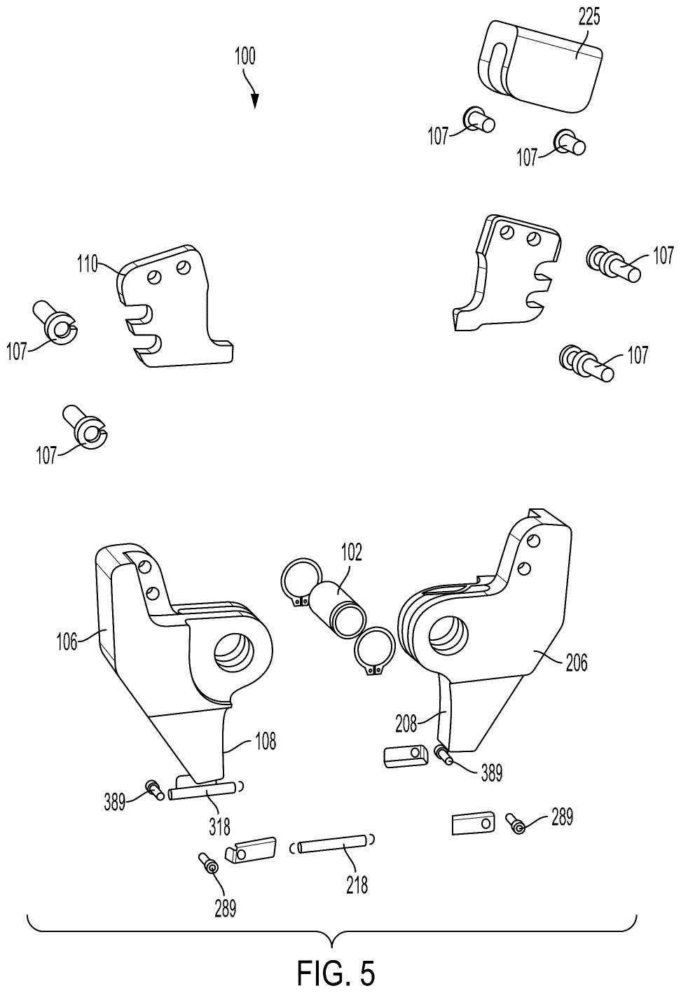

FIG. 5 is an exploded view of the shearing head 100.

FIG. 6 is a close up view of the blade retainer 225. FIG. 6 shows how a surface 241 of the blade retainer 225 is configured to resist (leftward) motion of the first shearing member 110 that is normal to the shearing plane during a shearing operation. In FIG. 6, the shearing plane is vertically aligned with respect to the paper and extends into and out of the paper.

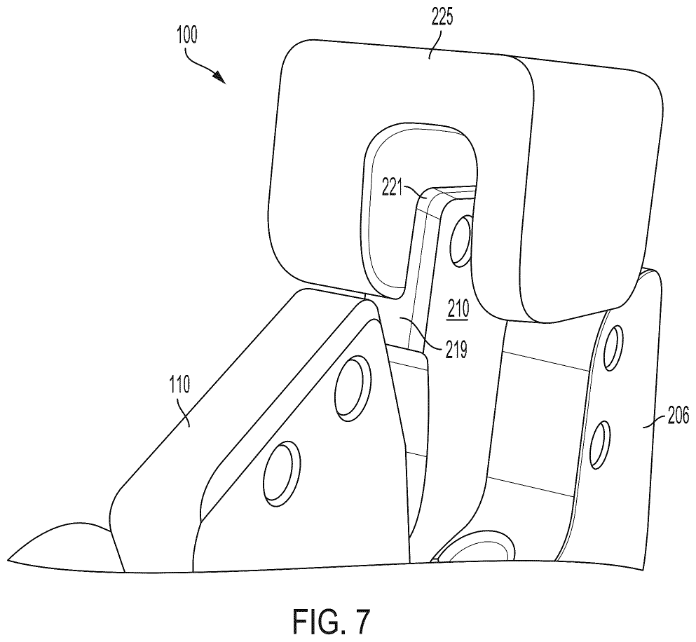

FIG. 7 is another close up view of the blade retainer 225.

FIG. 8 is another close up view of the blade retainer 225.

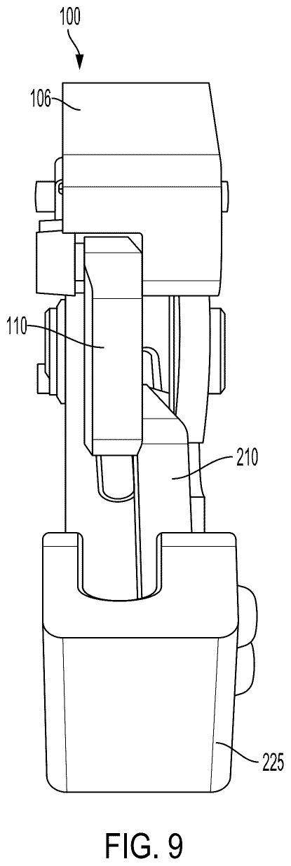

FIG. 9 is a top view of the shearing head 100.

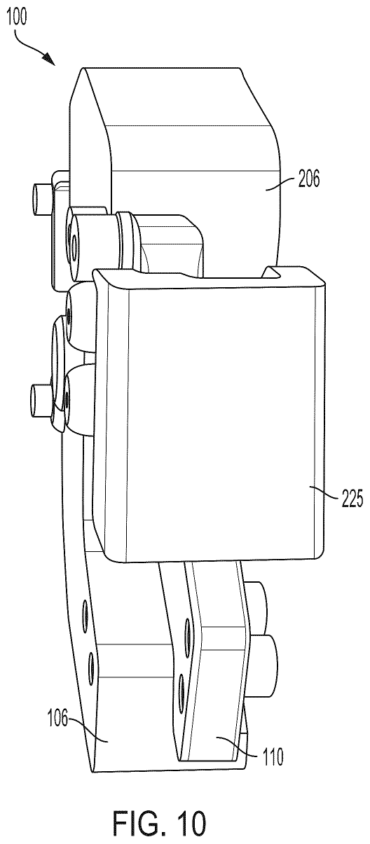

FIG. 10 is another top view of the shearing head 100.

The description of the different advantageous embodiments has been presented for purposes of illustration and description, and is not intended to be exhaustive or limited to the embodiments in the form disclosed. Many modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A blade retainer configured to couple to a blade, the blade retainer comprising:
a first end face defining a first end of the blade retainer;
a second end face opposite the first end face and defining a second end of the blade retainer; and
a first contacting face positioned between the first end face and the second end face, the first contacting face configured to contact the blade.

2. The blade retainer of claim 1, further comprising a channel extending from the first end face toward the second end face.

3. The blade retainer of claim 2, wherein a recess is defined within the channel, the recess defined by the first contacting face.

4. The blade retainer of claim 3 further comprising a second contacting face defining the recess, the second contacting surface extending from the first contacting face and toward the second end face.

5. The blade retainer of claim 4 further comprising a third contacting face defining the recess, the third contacting surface extending from the first contacting face toward the second end face.

6. The blade retainer of claim 5, wherein the first contacting face is perpendicular to the second contacting face and the third contacting face, and the second contacting face is perpendicular to the third contacting face.

7. The blade retainer of claim 5, wherein the third contacting face defines an opening configured to receive a fastener for attaching the blade retainer to the blade.

8. The blade retainer claim 1, wherein the first contacting face is parallel to the first end face.

9. The blade retainer of claim 8, further comprising:
a first outer face extending from the first end face to the second end face,
a second outer face opposite the second end face, the second outer face extending form the first end face to the second end face; and
a third outer face extending from the first end face to the second end face and from the first outer face to the second outer face.

10. The blade retainer of claim 9, wherein the first outer face is parallel to the second outer face, and the third outer face is perpendicular to the first outer face.

11. A blade retainer configured to couple to a blade, the blade retainer comprising:
a retainer body including a first leg, a second leg, and a channel extending between the first leg and the second leg,
the first leg defining a recess within the channel, the recess configured to receive the blade.

12. The blade retainer of claim 11, wherein the first leg defines a first surface corresponding to a first end of the retainer body and a second surface corresponding to a second end of the retainer body, and
wherein the recess is defined by a third surface that is configured to engage the blade.

13. The blade retainer of claim 12, wherein the recess is further defined by a fourth surface and a fifth surface, each of the fourth surface and the fifth surface configured to engage the blade.

14. The blade retainer of claim 13, wherein the third surface, the fourth surface, and the fifth surface are perpendicular to one another.

15. The blade retainer of claim 11, wherein the first leg defines a hole configured to receive a fastener for attaching the blade retainer to the blade.

16. The blade retainer of claim 15, wherein the hole is positioned within the recess.

17. A power tool comprising:
a first blade defining a first shearing surface;
a second blade defining a second shearing surface and a first surface that faces the first shearing surface; and
a blade retainer including a first retainer surface in contact with the first surface.

18. The power tool of claim 17, wherein at least one of the first blade and the second blade is moveable along a shearing plane and the first surface is at a non-zero angle relative to the shearing plane.

19. The power tool of claim 18, wherein the second blade defines a second surface and the blade retainer defines a second retainer surface in contact with the second surface, and
wherein the second blade defines a third surface and the blade retainer defines a third retainer surface in contact with the third surface.

20. The power tool of claim 19, wherein the second surface is parallel to the shearing plane and the third surface is perpendicular to the first surface and the shearing plane.
